(19) United States
(12) Patent Application Publication
(10) Pub. No.: US 2013/0206322 A1
(43) Pub. Date: Aug. 15, 2013

(54) METHOD FOR MAKING A BASE LAYER OF A SOLID TIRE AND APPARATUS THEREFOR

(71) Applicant: Continental Reifen Deutschland GmbH, (US)

(72) Inventors: Siegbert Steuber, Korbach (DE); Alexander Kraus, Diemelsee (DE); Ralf Jacob, Korbach (DE); Stephan Disselhoff, Korbach (DE); Hartwig Poque, Korbach (DE)

(73) Assignee: Continental Reifen Deutschland GmbH, Hannover (DE)

(21) Appl. No.: 13/840,888

(22) Filed: Mar. 15, 2013

Related U.S. Application Data
(63) Continuation of application No. PCT/EP2011/063432, filed on Aug. 4, 2011.

(30) Foreign Application Priority Data
Sep. 16, 2010 (DE) 10 2010 037 571.3

(51) Int. Cl. B29D 30/00

(52) U.S. Cl. CPC B29D 30/0016
USPC 156/112; 156/404

(57) ABSTRACT

An apparatus makes a base layer of solid tire blanks having a radially inner rubber-under-core-ply, a middle core ply and a radially outer covering layer and includes a pivoting block having first and second winding drums and a winding system for depositing the rubber-under-core ply and the covering layer on the winding drums. A laying unit has a wire feeder and deposits the core ply on the winding drums. The pivot block defines an axis and is pivotable between first and second positions and is arranged between the winding system and the laying unit causing the first drum to be assigned to the winding system and the second drum to be assigned to the laying unit in the first position. The pivoting block pivots to the second position causing the first drum to foe assigned to the wire feeder and the second drum to be assigned to the winding system.

### CROSS REFERENCE TO RELATED APPLICATIONS

This application is a continuation application of international patent application PCT/EP2011/063432, filed Aug. 4, 2011, designating the United States and claiming priority from German application 10 2010 037 571.3, filed Sep. 16, 2010, and the entire content of both applications is incorporated herein by reference.

### FIELD OF THE INVENTION

The invention relates to an apparatus and a method for producing a base layer of a solid tire,

### BACKGROUND OF THE INVENTION

The structure of a solid tire is sufficiently well known to a person skilled in the art. Solid tires are made essentially of rubber or rubber-like plastic and have a tread strip, a base layer and a damper layer optionally arranged between the base layer and the tread strip. The base layer of the solid tire has a three-part structure: arranged radially on the inside is the so-called “rubber-under-core ply”, on which there follows the core ply, which in turn is covered radially on the outside by the covering layer.

Until now, the base layer has been produced by first the rubber-under-core ply being extruded and cut to length and formed by hand into a closed base ring. The cores for the core ply are produced by coiling individual wires to form a separate assembly, a number of these assemblies being joined together to form the base-core assembly by the rubber-under-core ply and the core assemblies being connected by hand. This base-core assembly is arranged on a winding drum, onto which the radially outer layer of the base layer, the calendered covering layer, is subsequently wound.

To automate the production of the base layer, it is known from DK 43 13 916 A1 to create the core ply by winding a rubberized individual filament or cord or wire in numerous turns.

Coiling of the core ply makes it possible for the base layer of the solid tire to be produced more efficiently. However, there is still a demand to make the production of the solid tire even more efficient.

### SUMMARY OF THE INVENTION

It is an object of the invention to provide an apparatus and a method by which the making of a solid tire can be made more efficient.

This object is achieved according to the invention with respect to the apparatus by the apparatus having a pivoting block with two winding drums, a winding system for feeding and depositing the rubber-under-core ply and the covering layer on the winding drum, a laying unit with a wire feeder for feeding and depositing the core ply on the winding drum, the pivoting block with the two winding drums being arranged between the winding system and the laying unit in such a manner that, in a first position, the first winding drum is assigned to the winding system and the second winding drum is assigned to the wire feeder, and the pivoting block being pivotable about an axis in such a way that, in a second position, the first winding drum is assigned to the wire feeder and the second winding drum is assigned to the winding system.

It is a feature of the invention that, with the apparatus according to the invention, two base layers can be produced in an automated manner parallel to each other—displaced by a building step—on separate winding drums alternately on the same winding system and laying unit. The rubber-under-core ply and the covering layer are calendered plies, which can be fed and deposited on and around the winding drum by the winding system in an automated manner, while the core ply can be coiled, by the laying unit. By pivoting the pivoting block into positions 1 and 2, each of the two winding drums can alternately be assigned to both the same winding system and. the same wire feeder, More efficient production of the base layer with considerably lower production, tolerances is made possible.

In a preferred embodiment of the apparatus, the wire feeder is movable in the axial direction and/or radial direction with respect to the winding drum.

This achieves the effect that any conceivable coiling pattern can be coiled as a core ply, whereby optimum properties of the core ply can be obtained.

In a further preferred embodiment of the invention, the laying unit is configured in such a manner that a bundle of rubberized reinforcing elements can be laid. As a result, a time advantage can foe achieved in the production process. The solid tire that has bundles of rubberized reinforcing elements as its core ply is distinguished by a more uniform distribution of forces.

In a further preferred embodiment of the invention, a bundle consists of three, four, five or six pre-rubberized reinforcing elements, preferably steel reinforcing elements.

The object is achieved according to the invention with respect to the method in that the following steps are performed sequentially:
pivoting the pivoting block about its axis into the first position, so that the first winding drum is assigned to the winding system and the second winding drum is assigned to the wire feeder;
applying a rubber-under-core ply to the first winding drum, by the ply being fed from the winding system and placed onto and around the rotating winding drum;
pivoting the pivoting block about its axis into the second position, so that the first winding drum is assigned to the wire feeder and the second winding drum is assigned to the winding system;
coiling the core ply from a bundle of pre-rubberized reinforcing elements onto the rubber-under-core ply of the first winding drum and preferably at the same time applying a rubber-under-core ply to the second rotating winding drum, by the ply being fed from the winding system and placed onto and around the second rotating winding drum;
pivoting the pivoting block about its axis into the first position, so that the first winding drum is assigned to the winding system and the second winding drum is assigned to the wire feeder;
applying the covering layer to the first winding drum, by the ply being fed from the winding system and placed onto and around the first rotating winding drum, removing the base layer from the first winding drum and at the same time coiling from a bundle of pre-rubberized reinforcing elements onto the rubber-under-core ply of the rotating second winding drum;
preferably pivoting the pivoting block about its axis, so that, in the second position, the first winding drum is assigned to the wire feeder and the second winding drum is assigned to the winding system; and,
applying the covering layer to the core ply of the second winding drum, by the ply being fed from the winding system and placed onto and around the core ply of the second rotating winding drum and removing the base layer from the second winding drum.

The advantages achieved according to the invention are the advantages described with respect to the apparatus.

In a preferred embodiment of the method, the wire feeder is moved in the axial direction and/or radial direction with respect to the winding drum. This achieves the effect that any conceivable coiling pattern can be coiled as a core ply, whereby optimum properties of the core ply can be obtained.

In a further preferred embodiment of the method, it is provided that a bundle of three, four, five or six pre-rubberized reinforcing elements, preferably steel reinforcing elements, is laid.

### BRIEF DESCRIPTION OP THE DRAWINGS

The invention will now be described with reference to the drawings wherein:

FIG. 1 is a cross section through a solid tire having a base layer; and,

FIG. 2 is a plan view of an apparatus according to the invention for the automated production of the base layer.

### DESCRIPTION OF THE PREFERRED EMBODIMENTS OF THE INVENTION

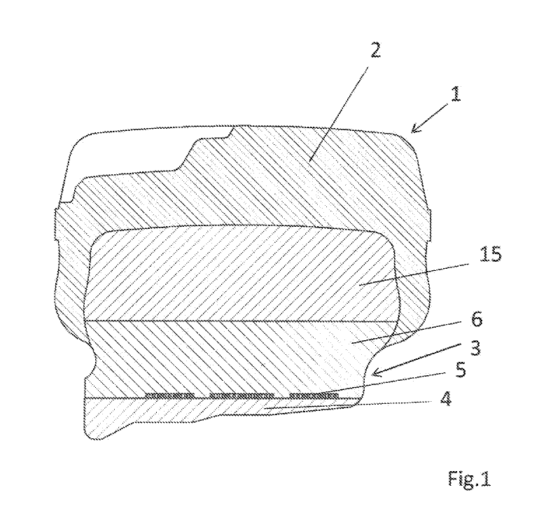

The solid tire 1 of FIG. 1 is made essentially of a tread strip 2, a base layer 3 and. a damper layer 15 arranged between the base layer 3 and the tread strip 2. The base layer 3 is formed from a very hard and tough rubber, while the rubber of the tread strip 2 is of a more elastic formulation and is additionally chosen to be extremely wear-resistant. The base layer 3 of the solid tire 1 has a three-part structure; arranged radially on the inside is the so-called “rubber-under-core ply” 4, followed by the core ply 5, which, is covered radially on the outside by the covering layer 6. The flat core ply 5 is coiled.

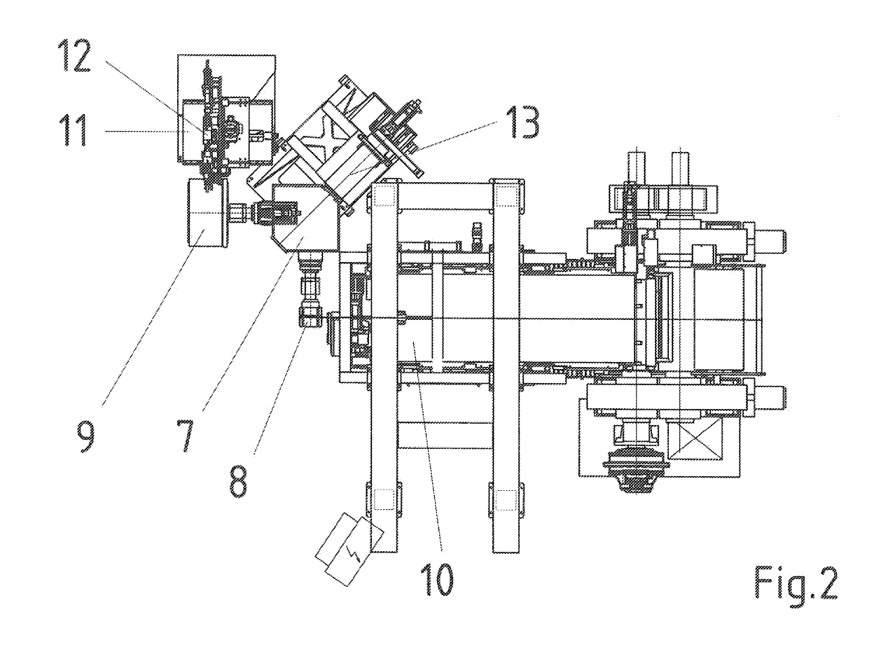

FIG. 2 shows a plan view of an apparatus according to the invention for the automated production of the base layer 3 of a solid tire 1 of FIG. 1. The apparatus has a pivoting block 7 with two rotatable winding drums (8, 9), a winding system 10 for feeding and depositing the rubber-under-core ply 4 and the covering layer 6 on the winding drum (8, 9), a laying unit 11 with a wire feeder 12 for feeding and depositing the core ply 5 by coiling on the winding drum (8, 9). The pivoting block 7 with the two winding drums (8, 9) is arranged between the winding system 10 and the wire feeder 12 in such a way that, in a first position, the first winding drum 8 is assigned to the winding system 10 and the second winding drum 9 is assigned to the wire feeder 12, The pivoting block 7 is pivotable about an axis 13 in such a way that, in a second position, the first winding drum 8 is assigned to the wire feeder 12 and the second winding drum 9 is assigned to the winding system 10. The wire feeder 12 is movable in the radial and axial directions with respect to the winding drums (8, 9) and is so configured, that it can apply a bundle consisting of 3 to 6 rubberized reinforcing elements.

To make the base layer 3 with this apparatus, the following steps are carried out:
pivoting the pivoting block 7 about its axis 13 into the first position, so that the first winding drum 8 is assigned, to the winding system 10 and the second winding drum 9 is assigned to the wire feeder 12;
applying a rubber-under-core ply 4 to the first winding drum 8, by the ply 4 being fed from the winding system 10 and placed onto and around the rotating first winding drum 8;
pivoting the pivoting block 7 about its axis 13 into the second position, so that the first winding drum 8 is assigned to the wire feeder 12 and the second winding drum 9 is assigned to the winding system 10;
coiling the core ply 5 from a bundle of pre-rubberized reinforcing elements onto the rubber-under-core ply 4 of the first winding drum 8 and at the same time applying a rubber-under-core ply 4 to the second rotating winding drum 9, by the ply 9 being fed from the winding system 10 and placed onto and around the second rotating winding drum 9;
pivoting the pivoting block 7 about its axis 13 into the first position., so that the first winding drum 8 is assigned to the winding system 10 and the second winding drum 9 is assigned to the wire feeder 12;
applying the covering layer 6 to the first winding drum 8, by the ply 6 being fed from the winding system 10 and placed onto and around the first rotating winding drum 8, removing the base layer 3 from the first winding drum 8 and at the same time coiling the core ply 5 from a bundle of pre-rubberized reinforcing elements onto the rubber-under-core ply 4 of the rotating second winding drum 9;
pivoting the pivoting block 7 about its axis 13, so that, in the second position, the first winding drum 8 is assigned to the wire feeder 12 and the second winding drum 9 is assigned to the winding system 10; and,
applying the covering layer 6 to the core ply 5 on the second winding drum 9, by the ply 9 being fed from the winding system 10 and placed onto and around the core ply 5 of the second rotating winding drum 9 and removing the base layer 3 from the second winding drum 9.

The base-under-core ply and the covering ply are calendered, while the core ply is coiled,

“Calendering” means the creation of a thin sheet of rubber mixture with the aid of two counter-rotating roils. This sheet of mixture is brought to a desired width that corresponds to the width of the component in the tire blank by cutting blades.

“Coiling” means the winding of an individual filament or wire, a cord or a bundle of reinforcing elements, for example of steel wire, into numerous axially adjacent or superjacent turns ever the circumference of the winding drum.

It is understood that the foregoing description is that of the preferred embodiments of the invention and that various changes and modifications may be made thereto without departing from the spirit and scope of the invention as defined in the appended claims.

### LIST OF DESIGNATIONS

### Part of the Description

1 Solid tire
2 Tread strip
3 Base layer
4 Rubber-under-core ply
5 Core ply
6 Covering layer
7 Pivoting block
8 First winding drum
9 Second winding drum
10 Winding system
11 Laying unit
12 Wire feeder
13 Axis of pivoting block
15 Damper layer

What is claimed is:

1. An apparatus for making a base layer of solid tire blanks having a radially inner rubber-under-core-ply, a middle core ply and a radially outer covering layer, the apparatus comprising:
a pivoting block having a first winding drum and a second winding drum;
a winding system configured for feeding and depositing the rubber-under--core ply and the covering layer on said first and said second winding drums;
a laying unit having a wire feeder and configured to feed and deposit the core ply on said first and said second winding drums;
said pivot block defining an axis and being pivotable between a first position and a second position; and,
said pivoting block with said first and said second winding drums being arranged between said winding system and said laying unit so as to cause said first winding drum to be assigned to said winding system and said second winding drum to be assigned to said laying unit in said first position of said pivoting block and said pivoting block being configured, to be pivotable to said second position so as to cause said first winding drum to be assigned to said wire feeder and said second winding drum to be assigned to said winding system.

2. The apparatus of claim 1, wherein said wire feeder is movable in at least one of an axial direction and a radial direction with reference to said winding drums.

3. The apparatus of claim 1, wherein said laying unit is configured to lay bundles of rubberized reinforcing elements.

4. The apparatus of claim 3, wherein each of said bundles has one of three, four, five and six pre-rubberized reinforcing elements.

5. The apparatus of claim 4, wherein said reinforcing elements are steel reinforcing elements.

6. A method for making a base layer of a solid tire having a rubber-under-core ply, a core ply and a covering layer with an apparatus for making a base layer of solid tire blanks having a radially inner rubber-under-core-ply, a middle core ply and a radially outer covering layer, the apparatus having a pivoting block having a first winding drum and a second winding drum, a winding system configured for feeding and depositing the rubber-under-core ply and the covering layer on said first and said second winding drums, a laying unit having a wire feeder and configured to feed and deposit the core ply on said first, and said second winding drums, said pivot block defining an axis and being pivotable between a first position and a second position, said, pivoting block with, said first and said second winding drums being arranged between said winding system and said laying unit so as to cause said first winding drum to be assigned to said winding system and said second winding drum to be assigned to said laying unit in said first position of said pivoting block and said pivoting block being configured to be pivotable to said second position so as to cause said first, winding drum to be assigned to said wire feeder and said second winding drum to be assigned to said winding system, the method comprising the steps of:
(a) pivoting the pivoting block about its axis into the first position so that the first winding drum is assigned to the winding system and the second winding drum is assigned to the wire feeder;
(b) applying a rubber-under-core ply to the first winding drum by feeding the ply from the winding system and placing the ply onto and around the rotating winding drum;
(c) pivoting the pivoting block about its axis into the second position so that the first warding drum is assigned to the wire feeder and the second winding drum is assigned to the winding system;
(d) coiling the core ply from a bundle of pre-rubberized reinforcing elements onto the rubber-under-core ply of the first winding drum;
(e) applying a rubber-under-core ply to the second rotating winding drum, by feeding the ply from the winding system and placing the ply onto and around the second rotating winding drum;
(f) pivoting the pivoting block about its axis into the first position, so that the first winding drum is assigned to the winding system and the second winding drum is assigned to the wire feeder;
(g) applying the covering layer to the first winding drum, by feeding the ply from the winding system and placing the ply onto and around the first rotating winding drum;
(h) removing the base layer from the first winding drum and simultaneously coiling from a bundle of pre-rubberized reinforcing elements onto the rubber-under-core ply of the rotating second winding drum;
(i) applying the covering layer to the core ply of the second winding drum, by feeding the ply from the winding system and placing the ply onto and around the core ply of the second rotating winding drum; and,
(j) removing the base layer from the second winding drum.

7. The method of claim 6, further comprising the step of:
after step (h), pivoting the pivoting block about its axis, so that, in the second position, the first winding drum is assigned to the wire feeder and the second winding drum is assigned to the winding system.

8. The method of claim 6, wherein the wire feeder is moved in at least one of the axial direction with respect to the winding drum and the radial direction with respect to the winding drum.

9. A method for making a base layer of a solid tire having a rubber-under-core ply, a core ply and a covering layer with an apparatus for making a base layer of solid tire blanks having a radially inner rubber-under-core-ply, a middle core ply and a radially outer covering layer, the apparatus having a pivoting block having a first: winding drum and a second winding drum, a winding system, configured for feeding and depositing the rubber-under-core ply and the covering layer on said first and said second winding drums, a laying unit having a wire feeder and configured to feed and deposit the core ply on said first and said second winding drums, said pivot block defining an axis and being pivotable between a first position and a second position, said pivoting block with said first and said second winding drums being arranged between said winding system and said laying unit so as to cause said first winding drum to be assigned to said winding system and said second winding drum to be assigned to said laying unit in said first position of said pivoting block and said pivoting block being configured to be pivotable to said second position so as to cause said first winding drum to be assigned to said wire feeder and said second winding drum to be assigned to said winding system, the method comprising the steps of:
pivoting the pivoting block about its axis into the first position so that the first winding drum is assigned to the winding system and the second winding drum is assigned to the wire feeder;
applying a rubber-under-core ply to the first winding drum by the ply being fed from the winding system and placed onto and around the rotating winding drum;
pivoting the pivoting block about its axis into the second position so that the first windbag drum is assigned to the wire feeder and the second winding drum is assigned to the winding system;
coiling the core ply from a bundle of pre-rubberized reinforcing elements onto the rubber-under-core ply of the first winding drum and simultaneously applying a rubber-under-core ply to the second rotating winding drum, by feeding the ply from the winding system and placing the ply onto and around the second rotating winding drum;
pivoting the pivoting block about its axis into the first position, so that the first winding drum is assigned to the winding system and the second winding drum is assigned to the wire feeder;
applying the covering layer to the first winding drum, by feeding the ply from the winding system and placing the ply onto and around the first rotating winding drum;
removing the base layer from the first winding drum and simultaneously coiling from a bundle of pre-rubberized reinforcing elements onto the rubber-under-core ply of the rotating second winding drum;
pivoting the pivoting block about its axis, so that, in the second position, the first winding drum is assigned to the wire feeder and the second winding drum is assigned to the winding system;
applying the covering layer to the core ply of the second winding drum, by feeding the ply from the winding system and placing the ply onto and around the core ply of the second rotating winding drum; and,
removing the base layer from the second winding drum.

10. The method of claim 9, wherein said reinforcing elements are steel reinforcing elements.
